(19) United States
(12) Patent Application Publication
(10) Pub. No.: US 2005/0172487 A1
(43) Pub. Date: Aug. 11, 2005

(54) Method for working nut screw for ball screw

(76) Inventors: Toru Kamiya, Gunma (JP); Tsutomu Adachi, Gunma (JP); Takaji Iwasawa, Gunma (JP)

Correspondence Address: SUGHRUE MION, PLLC, 2100 PENNSYLVANIA AVENUE, N.W., SUITE 800, WASHINGTON, DC, 20037, US

(21) Appl. No.: 10/483,888

(22) PCT Filed: Jul. 17, 2002
(86) PCT No.: PCT/JP02/07275

(30) Foreign Application Priority Data
Jul. 19, 2001 (JP) 2001-219880
Jul. 19, 2001 (JP) 2001-219881

(51) Int. Cl. F16H 1/24; B23P 17/00

(52) U.S. Cl. 29/898.066; 74/424.82; 29/898.067

(57) ABSTRACT

A method for working a nut screw for a ball screw has a first step of lathing or cutting a spiral-shaped rolling surface of the nut screw for a ball screw on which balls of the ball screw are allowed to roll, a second step of heat treating, for example, carburizing and quenching or high-frequency quenching the spiral-shaped rolling surface obtained in the first step to thereby harden the top surface layer of the rolling surface and, a third step of surface finishing the hardened top surface layer of the spiral-shaped rolling surface obtained in the second step according to an electrolytic polishing.

### TECHNICAL FIELD

The invention relates to a method for working a nut screw for a ball screw, including a deflector-type ball screw.

### BACKGROUND ART

A ball screw, which converts rotary motion into linear motion or converts linear motion into rotary motion, not only can amplify small torque to thereby provide large thrust but also is capable of accurate positioning in a linear direction. Thanks to such performance, the ball screw is widely used in a machine tool, a semiconductor-associated apparatus, and an industrial robot.

The ball screw, as shown in FIG. 4, includes a screw shaft 102 including a spiral-shaped groove 101 and a nut screw 104 including a spiral-shaped groove 103; and, a plurality of balls 105 are allowed to roll between the spiral-shaped grooves 101 and 103 of the screw shaft 102 and nut screw 104. The spiral-shaped groove 101 of the screw shaft 102 is formed by rolling work using a rolling die or by grinding into a Gothic-arch shape. On the other hand, the spiral-shaped groove 103 of the nut screw 104 is worked in the following manner.

That is, the blank material of the nut screw 104 is carburized and quenched, or is high-frequency quenched so as to have a given level of hardness. Next, as shown in FIG. 5, the spiral-shaped groove 103 is finished using a grindstone 107 mounted on the leading end portion of a rotary shaft 106 so as to have a Gothic-arch shape.

However, in the above method for grinding the inside diameter of the nut screw 104 using the grindstone 107 mounted on the leading end portion of the rotary shaft 106, the rotary shaft 106 must be formed so as to have a small diameter, so that the rotary shaft 106 is low in rigidity. Therefore, in the case of the thus-formed rotary shaft 106, it is difficult to work the blank material that has been processed by carburizing and quenching or by high-frequency quenching to have a given level of hardness. Also, when finishing the spiral-shaped groove 103 into a Gothic-arc-like spiral-shaped rolling surface 108, in case where the rolling surface 108 is not finished into a sufficiently smooth surface, a surface peel-off phenomenon occurs between the rolling surface 108 and the balls 105 rolling on the rolling surface 108 to thereby lower the life of the rolling surface 108. That is, it takes a lot of time to grind the spiral-shaped groove 103 using the grindstone 107.

Also, conventionally, there is used another method in which a spiral-shaped rolling surface, after completion of heat treatment, is finished using a lapping operation instead of a grinding operation. However, in this method, lapping bars similar in shape to the spiral-shaped rolling surfaces and having grains attached thereto must be manufactured for every shapes of the rolling surfaces, which gives rise to an increase in the manufacturing cost of the nut screw.

Further, FIGS. 6 and 7 shows a nut screw 201 for a deflector-type ball screw includes a spiral-shaped groove 202 formed in the inner peripheral surface thereof. In the outer peripheral surface of the nut screw 201, there is formed a deflector fit hole 204 into which a deflector 203 can be fitted and fixed. And, in order that the deflector fit hole 204 can be fitted with the deflector 203 with no clearance between them, the deflector fit hole 204 is worked so as to have the same shape as the deflector 203.

And, a plurality of balls 207 are allowed to roll between the spiral-shaped groove 205 of a ball screw 206 and the spiral-shaped groove 202 of the nut screw 201. Also, the balls 207 are disposed in the endless circulation passage 208 of the ball screw 206 and, in case where the nut screw 201 and ball screw 206 are rotated with respect to each other, the balls 207 are allowed to roll on the endless circulation passage through the circulation passage of the deflector 203.

By the way, conventionally, in a method for working the deflector fit hole 204, using a cutting tool such as a drill or an end mill, the nut screw 201 is cut from the outer peripheral surface side thereof. However, since a high thrust is required of the ball screw 206, the ball screw 206 increases in size and also the number of circulation passages increases. That is, in the conventional working method, the cutting removal amount increases as well as the working time increases in proportion to the increase in the cutting removal amount.

Also, as means for fixing the deflector 203 strongly to the nut screw 201, as shown in FIG. 8, a deflector fit hole 204′ to be formed in the nut screw 201 is structured in a dovetail groove which increases in width as it goes to the deep side thereof. And, after the deflector 203 is fitted into the deflector fit hole 204′, the deflector 203 is caulked and deformed using a punch 209, thereby preventing the deflector 203 from slipping off the deflector fit hole 204′.

However, in the conventional working method for cutting the nut screw 201 using a cutting tool such as a drill or an end mill, due to the increased size of the ball screw and the increased number of circulation passages, the cutting removal amount increases as well as the working time increases in proportion to the increase in the cutting removal amount. Also, in case where the deflector fit hole 204′ to be formed in the nut screw 201 is structured in a dovetail groove which increases in width as it goes to the deep side thereof, there is necessary a tool which is specially designed for such hole working. This increases the working time and thus gives rise to an increase in the working cost of the nut screw.

### DISCLOSURE OF INVENTION

The present invention aims at eliminating the drawbacks found in the above-mentioned conventional working methods of a nut screw for a ball screw. Accordingly, it is an object of the invention to provide a working method of a rolling surface of a nut screw for a ball screw, which can easily work the spiral-shaped rolling surface of the nut screw regardless of the size and shape thereof to thereby be able to shorten the working time of the nut screw and thus reduce the cost thereof.

Further, it is another object of the invention to provide a method for working a nut screw for a deflector-type ball screw, which not only can facilitate the working of the deflector fit hole in the nut screw to thereby shorten the working time and thus reduce the working cost of the nut screw, but also can facilitate the fixation of the deflector to the deflector fit hole to thereby reduce the working cost of the nut screw.

In attaining the above object, according to a first aspect of the invention, there is provided a method for working a nut screw for a ball screw, comprising: a first step of cutting the spiral-shaped rolling surface of the nut screw on which balls of the ball screw are allowed to roll; a second step of heat treating the spiral-shaped rolling surface obtained in the first step to thereby harden the surface of the rolling surface; and, a third step of surface finishing the surface hardened layer of the spiral-shaped rolling surface obtained in the second step according to an electrolytic polishing.

Also, according to a second aspect of the invention, in the method as set forth in the first aspect of the invention, the first step works the above-mentioned spiral-shaped rolling surface into a Gothic-arch shape by lathing the spiral-shaped rolling surface using a lathe or by cutting the spiral-shaped rolling surface using a rotary tool.

As described above, according to the invention, by working the rolling surface of the nut screw by lathing it using a lathe or by cutting it using a specially designed rotary tool into a Gothic-arch shape, the working time of the nut screw can be shortened and the working accuracy thereof can be enhanced. Also, after the blank material of the nut screw is heat treated and is thereby surface hardened, by treating only the rolling surface of the screw nut according to an electrolytic polishing method, the nut screw can be worked regardless of the size of the nut screw and the shape of the rolling surface.

Further, in attaining the above object, according to a third aspect of the invention, there is provided a method for working a nut screw for a deflector-type ball screw, comprising the steps of: radiating a laser beam onto a nut screw having a spiral-shaped groove formed in the inner peripheral surface thereof for allowing balls to roll thereon from the outer peripheral surface side of the nut screw to thereby form a deflector fit hole in the nut screw in such a manner that the deflector fit hole penetrates through the nut screw from the outer peripheral surface thereof up to the inner peripheral surface thereof; and, fitting and fixing a deflector for defining a circulation passage into the deflector fit hole.

Also, according to a fourth aspect of the invention, there is provided a method for working a nut screw for a deflector-type ball screw, comprising the steps of: forming a deflector fit hole in a nut screw having a spiral-shaped groove formed in the inner peripheral surface thereof for allowing balls to roll thereon in such a manner that the deflector fit hole penetrates through the nut screw from the outer peripheral surface thereof up to the inner peripheral surface thereof; fitting and fixing a deflector for defining a circulation passage into the deflector fit hole; and, after then, welding the deflector to the nut screw using a laser beam.

According to the third aspect of the invention, since the deflector fit hole is formed using a laser beam working operation, the material removal amount is limited to the contour passage of the deflector fit hole. Thanks to this, when compared with a conventionally known cutting operation, the working time can be shortened greatly.

Also, according to the fourth aspect of the invention, the deflector is welded to the nut screw using a laser beam working operation. This not only can eliminate the need for formation of a specially-shaped deflector fit hole for prevention of slippage of the deflector in the nut screw but also can omit the operation to caulk the deflector. Thanks to this, the working time can be shortened.

### BRIEF DESCRIPTION OF DRAWINGS

FIG. 1 is a longitudinal sectional side view of a ball screw, showing a first embodiment of to the invention;

FIG. 2 is a side view of a working apparatus for working a nut screw used in a deflector-type ball screw, showing a second embodiment of the invention;

FIG. 3 is a longitudinal sectional side view of part of a nut screw, showing a third embodiment of the invention;

FIG. 4 is a longitudinal sectional side view of a ball screw;

FIG. 5 is a longitudinal sectional side view of a conventional method for working the rolling surface of a nut screw;

FIG. 6 is a longitudinal sectional side view of a conventional nut screw;

FIG. 7 is a longitudinal sectional side view of a conventional deflector-type ball screw; and,

FIG. 8 is a longitudinal sectional side view of part of a conventional nut screw.

### MODES FOR CARRYING OUT THE INVENTION

Now, description will be given below of the preferred embodiments of a working method of a nut screw for a ball screw with reference to the accompanying drawings.

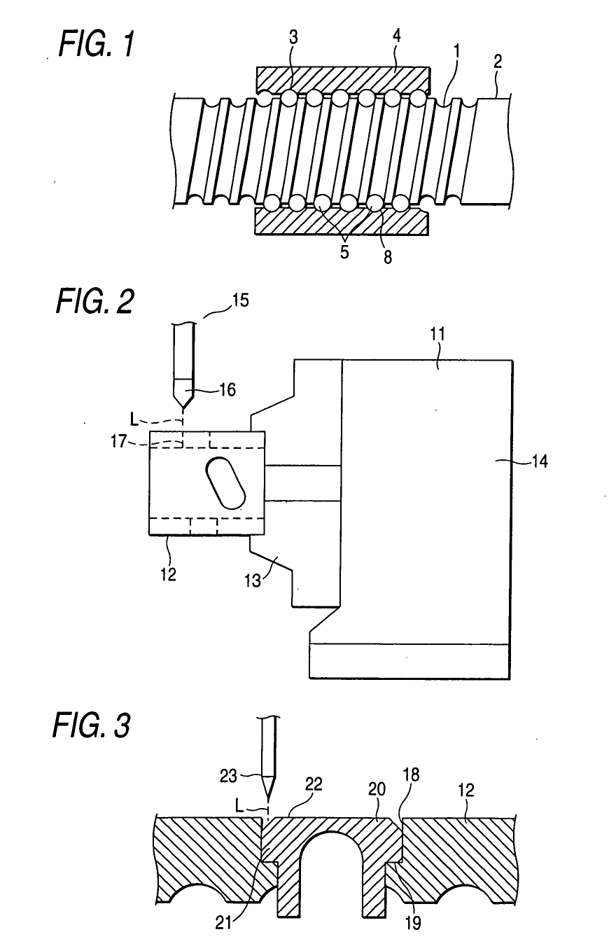

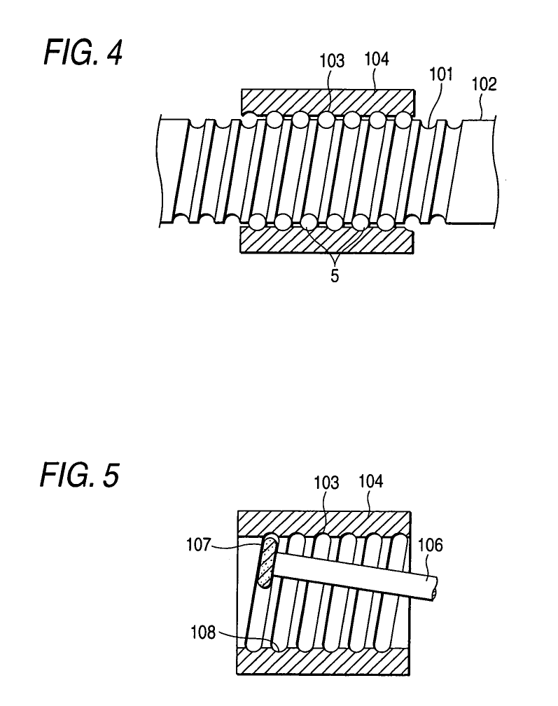

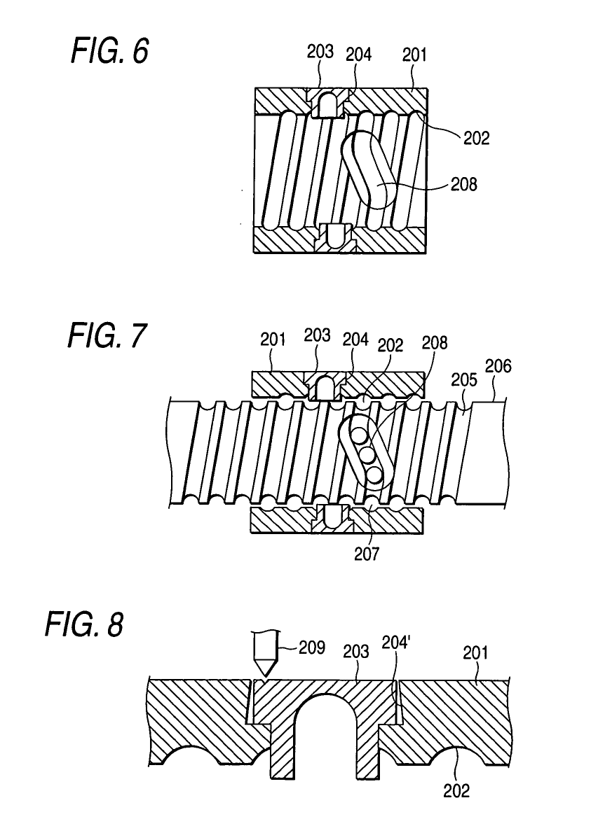

FIG. 1 is a longitudinal sectional side view of a ball screw according to a first embodiment of the invention. The ball screw includes a screw shaft 2 including a spiral-shaped groove 1 and a nut screw 4 including a spiral-shaped groove 3; and, a plurality of balls 5 are allowed to roll between the spiral-shaped grooves 1 and 3 of the screw shaft 2 and nut screw 4. The spiral-shaped groove 1 of the screw shaft 2, generally, is formed by a rolling work using a rolling die or by grinding so as to have a Gothic-arch shape. On the other hand, the spiral-shaped groove 3 of the nut screw 4 is worked using a lathe or is cut using a specially designed rotary tool so as to have a Gothic-arch shape.

Next, the blank material of the nut screw 4 is heat treated and is thereby surface hardened, for example, by carburizing and quenching, or by high-frequency quenching so that the rolling surface 8 of the nut screw 4 has a given level of hardness. In this state, however, the rolling surface 8 is not sufficiently smooth; and, therefore, after the surface hardening heat treatment of the nut screw 4, only the rolling surface 8 is surface modified according to an electrolytic polishing method so that the rolling surface 8 has a desired surface roughness.

In the electrolytic polishing method used in the present invention, while the nut screw 4 masked except for the rolling surface 8 to be polished electrolytically is considered as a positive electrode, in case where the positive electrode (the nut screw 4) is immersed together with a negative electrode in electrolyte and a direct current is allowed to flow through the two electrodes, the top surface of the rolling surface 8 is gradually caused to melt away, with the result that the top surface of the rolling surface 8 is turned into a new smooth surface.

In this manner, in case where the rolling surface 8 of the nut screw 4 is lathed using a lathe or is cut using a specially designed rotary tool into a Gothic-arch shape, the working time of the nut screw 4 can be shortened and the working accuracy thereof can be enhanced. Also, after the surface hardening heat treatment of the nut screw 4, by treating only the rolling surface 8 according to an electrolytic polishing method, the nut screw 4 can be worked regardless of the size thereof and the shape of the rolling surface 8.

FIG. 2 is a side view of an apparatus for working a nut screw used in a deflector-type ball screw according to a second embodiment of the invention. The nut screw working apparatus includes a work support mechanism 11 and, in the work support mechanism 11, there is disposed a chuck 13 for gripping a nut screw 12. The chuck 13 can position the nut screw 12 in the peripheral direction thereof and in the axial direction thereof using an NC (numerically controlled) index 14.

In the outer peripheral surface of the nut screw 12, there is formed a laser radiation port 16 of a laser working machine 15 in such a manner that it extends at right angles to the axis of the nut screw 12; and, a laser beam L, which is radiated from the laser radiation port 16, is applied to the outer peripheral surface of the nut screw 12 to thereby be able to form a deflector fit hole 17 which penetrates through the nut screw 12 from the outer peripheral surface thereof up to the inner peripheral surface thereof.

That is, at the same time when the chuck 13 moves the nut screw 12 in the peripheral direction thereof and in the axial direction thereof using the NC (numerically controlled) index 14, the laser beam L from the laser radiation port 16 is radiated to the outer peripheral surface of the nut screw 12. Therefore, the laser beam L is scanned along the contour passage of the deflector fit hole 17 to thereby form such deflector fit hole 17 in the outer peripheral surface of the nut screw 12 that penetrates through the nut screw 12 from the outer peripheral surface thereof up to the inner peripheral surface thereof. Into the deflector fit hole 17, similarly to the conventional structure, there can be fitted a deflector; and, the deflector can be fixed to the nut screw 12 by caulking or by screwing, or using a laser beam welding operation which provides a third embodiment of the invention to be discussed below.

In case where the deflector fit hole 17 is formed using the laser beam working operation in this manner, differently from the conventional cutting operation, the material removal amount by the laser beam is limited to the contour passage of the deflector fit hole 17, which makes it possible to shorten the working time greatly. Therefore, the second embodiment is effective in dealing with the increased size of the ball screw and the increased number of circulation passages.

Now, FIG. 3 is a longitudinal sectional side view of part of a nut screw 12 according to a third embodiment of the invention. In the nut screw 12, there is formed a deflector fit hole 18. And, the deflector fit hole 18 is wide in width on the outer peripheral portion side of the nut screw 12 and is narrow in width on the inner peripheral portion side of the nut screw 12, whereby there is formed a fitting stepped portion 19 in the deflector fit hole 18.

Also, a deflector 20 has a shape corresponding to the shape of the deflector fit hole 18 and includes an engaging edge portion 21 which can be engaged with the fitting stepped portion 19. Further, on the two side edge portions of the deflector 20, there are formed chamfered portions 22.

And, to fix the deflector 20 to the deflector fit hole 18, the deflector 20 may be fitted into the deflector fit hole 18 to thereby bring the fitting stepped portion 19 into engagement with the engaging edge portion 21. In this state, a laser beam L may be radiated from the laser radiation port 23 of the laser working machine to the connecting portion between the deflector fit hole 18 and deflector 20 to thereby laser weld the deflector 20 to the deflector fit hole 18, so that the deflector 20 can be fixed to the nut screw 12.

In this case, the portion to be heated and welded by the laser beam L is limited to a very small area, and the heated and welded portion can be hardly deformed due to heat. Also, there is eliminated the need for working of a taper hole for prevention of the deflector against slippage which can occur in the case of the conventional caulking operation, thereby being able to shorten the working time greatly.

While only certain embodiments of the invention have been specifically described herein, it will apparent that numerous modifications may be made thereto without departing from the spirit and scope of the invention.

### INDUSTRIAL APPLICABILITY

A working method of a nut screw of a ball screw of the invention, by lathing or cutting the blank material of the nut screw prior to the heat treatment thereof to thereby form the rolling surface of the nut screw, the working efficiency of the nut screw can be enhanced and the working time thereof can be shortened.

Also, after the blank material of the nut screw is heat treated and surface hardened, by treating only the rolling surface of the nut screw according to an electrolytic polishing method, not only the nut screw including the rolling surface can be worked regardless of the size of the nut screw and the shape of the rolling surface, but also the working cost of the nut screw can be reduced.

In addition, since the deflector fit hole is formed according to a laser beam working operation, the material removal amount is limited to the contour passage of the deflector fit hole. Thanks to this, when compared with the conventionally used cutting operation, the invention not only can shorten the working time greatly but also is effective in dealing with the increased size of the ball screw and the increased number of circulation passages.

Also, because the deflector is welded to the nut screw using a laser beam, there is eliminated the need for formation of a specially-shaped deflector fit hole for prevention of slippage of the deflector in the nut screw, and there is eliminated the need for execution of the operation to caulk the deflector. Thanks to this, the working time can be shortened and thus the working cost can be reduced.

1. A method for working a nut screw for a ball screw, comprising:
a first step of cutting a spiral-shaped rolling surface of the nut screw on which balls of the ball screw are allowed to roll;
a second step of heat treating the spiral-shaped rolling surface obtained in the first step for surface hardening to thereby obtain a surface hardened layer on the rolling surface; and,
a third step of surface finishing the surface hardened layer obtained in the second step according to an electrolytic polishing.

2. The working method according to claim 1, wherein the electrolytic polishing is performed by masking a portion of the nut screw other than the rolling surface so as to serve as a positive electrode.

3. The working method according to claim 1, wherein the first step works the spiral-shaped rolling surface into a Gothic-arch shape by lathing the spiral-shaped rolling surface using a lathe or by cutting the spiral-shaped rolling surface using a rotary tool.

4. A method for working a nut screw for a deflector-type ball screw, comprising the steps of:
radiating a laser beam onto an outer peripheral surface side of the nut screw having a spiral-shaped groove formed in the inner peripheral surface thereof for allowing balls to roll thereon to thereby form a deflector fit hole in the nut screw in such a manner that the deflector fit hole penetrates through the nut screw up to the inner peripheral surface of the nut screw; and,
fitting and fixing a deflector for defining a circulation passage into the deflector fit hole.

5. The working method according to claim 4, further comprising the steps of:
cutting the spiral-shaped groove;
heat treating the cut spiral-shaped groove for surface hardening to thereby obtain a surface hardened layer on the spiral-shaped groove; and,
surface finishing the surface hardened layer according to an electrolytic polishing.

6. A method for working a nut screw for a frame-type ball screw, comprising the steps of:
forming a deflector fit hole in the nut screw having a spiral-shaped groove formed in the inner peripheral surface thereof for allowing balls to roll thereon in such a manner that the deflector fit hole penetrates the nut screw from the outer peripheral surface thereof up to the inner peripheral surface thereof;
fitting a deflector for defining a circulation passage into the deflector fit hole; and,
welding said deflector to said nut screw using a laser beam.
